(19) United States
(12) Patent Application Publication
(10) Pub. No.: US 2006/0145659 A1
(43) Pub. Date: Jul. 6, 2006

(54) Battery pack system and method for waking up a charge control circuit of a mobile communication device

(76) Inventors: Joseph Patino, Pembroke, FL (US); Andrew F. Burton, Coral Springs, FL (US); Russell L. Simpson, Miami, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/027,075

(22) Filed: Dec. 31, 2004

(51) Int. Cl. H02J 7/00

(52) U.S. Cl. 320/108

(57) ABSTRACT

A battery pack (104) has an inductive charging interface (112) for charging a battery cell (114) upon coupling to an inductive power supply (210). The battery pack is coupled to a mobile communication device via a radio interface (110), through with a voltage level is applied to a charge monitoring circuit (106). When the mobile communication device is powered off, the voltage level wakes up the charge monitoring circuit so that the charging status of the battery cell can be displayed on the mobile communication device.

### TECHNICAL FIELD

This invention relates in general to mobile communication devices and battery packs for mobile communication devices, and more particularly to battery packs having an inductive charging interface where a charge monitoring circuit of the mobile communication device provides a charging status on the mobile communication device while the mobile communication device is otherwise powered off.

### BACKGROUND OF THE INVENTION

Mobile communication devices are in widespread use throughout the world, and particularly in metropolitan regions. Since users of these devices tend to keep them powered on to make and receive calls, secondary or rechargeable batteries are preferred over primary batteries since there is a substantial cost benefit as rechargeable batteries can be used hundreds of cycles. Rather than have a user handle multiple rechargeable cells, manufacturers have instead incorporated rechargeable cells into battery packs for ease of use. A wide variety of battery packs exist, with many different features.

One feature that is gaining interest is inductive charging systems. In an inductive charging system the battery pack is charged through an inductive or magnetic link with an inductive power supply. In conventional charging designs an electrical connection is used, which requires the physical contact of electrically conductive elements between the charger and the battery pack, or between the charger and the mobile communication device if the battery pack is charged through the mobile communication device.

The design of having the battery charged through the mobile communication device has become quite popular. Typically a plug terminal connected to a wall-mount transformer power supply is plugged into a connector interface on the mobile communication device. Upon connecting the power supply, the mobile communication device recognizes the presence of the power source, and activates a charge monitoring circuit which provides a charging status displayed or otherwise indicated to the user of the mobile communication device. Even when the mobile communication device is turned off, the presence of the power supply activates the charge monitoring circuit so that, even though the mobile communication device remains powered off, the user may be informed as to the charge status of the battery. However, in inductive charging designs, there is no physical electrical connection by which to activate the charge monitoring circuit. Furthermore, to avoid adding cost to the mobile communication device, it is preferable to design the inductive charging feature into a specialized battery pack. Therefore there is a need by which the charge monitoring circuit of a mobile communication device can be activated when used with an inductively charged battery pack.

### BRIEF DESCRIPTION OF THE DRAWINGS

FIG. 1 shows a block schematic diagram of a battery pack and mobile communication device system, in accordance an embodiment of the invention.

FIG. 2 shows a detailed block schematic drawing of a battery pack and mobile communication device system, in accordance an embodiment of the invention;

FIG. 3 shows a flow chart diagram of a method of waking up a charge monitoring circuit of a mobile communication device from a battery pack having an inductive charging interface, in accordance with an embodiment of the invention;

FIG. 4 shows a flow chart diagram of a method of waking up a charge monitoring circuit of a mobile communication device from a battery pack, in accordance with one embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

The invention solves the problem of not being able to activate a charge monitoring circuit in a mobile communication device when the battery pack is charged by an inductive charger by providing a pass through line between the inductive charging interface and the charge monitoring circuit through a radio interface connecting the battery pack and mobile communication device together.

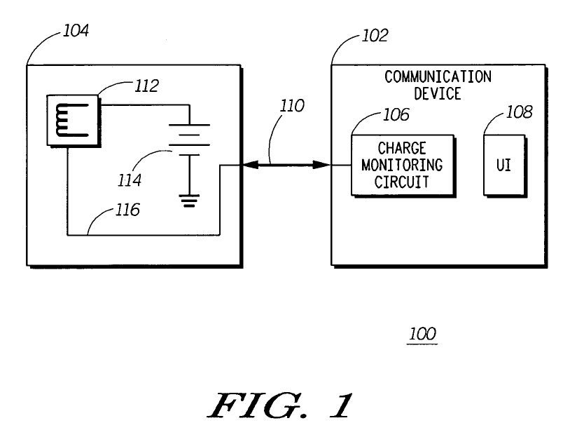

Referring now to FIG. 1, there is shown a schematic block diagram 100 of a battery pack and mobile communication device system, in accordance an embodiment of the invention. A communication device 102 such as a mobile communication device, cellular phone, or other radio communication device, is coupled to a rechargeable battery pack 104. The communication device comprises a charge monitoring circuit 106 which monitors the state of charge of battery cell or cells 114 in the battery pack, and provide an indication of the state of charge on, for example, a user interface element 108 of the communication device. The charge monitoring circuit may observe a voltage level of the battery cell, or it may receive information from a controller in the battery pack which measures charging current as well as voltage, for example. The user interface element may be, for example, a bar graph display on a display element of the communication device.

The battery pack 104 comprises an inductive charging interface 112 which can couple, inductively, to an inductive power supply. The inductive charging interface is coupled to the battery cells 114 and provides charging current to charge the battery cells. The battery pack also has a pass through line 116 coupled between the inductive charging interface 112 and the radio interface 110. Furthermore, the pass though line is continued on in the communication device and coupled to the charge monitoring circuit 106. When the battery pack is placed in, or otherwise coupled to an inductive power supply, a voltage is produced at the inductive charge interface 112, which is evident on the pass through line 116, and is used to activate the charge monitoring circuit 106 when the communication device is powered off. The pass through line may be directly coupled to the charge monitoring circuit, or it may be used, for example, to trigger a switch to provided power to the charge monitoring circuit.

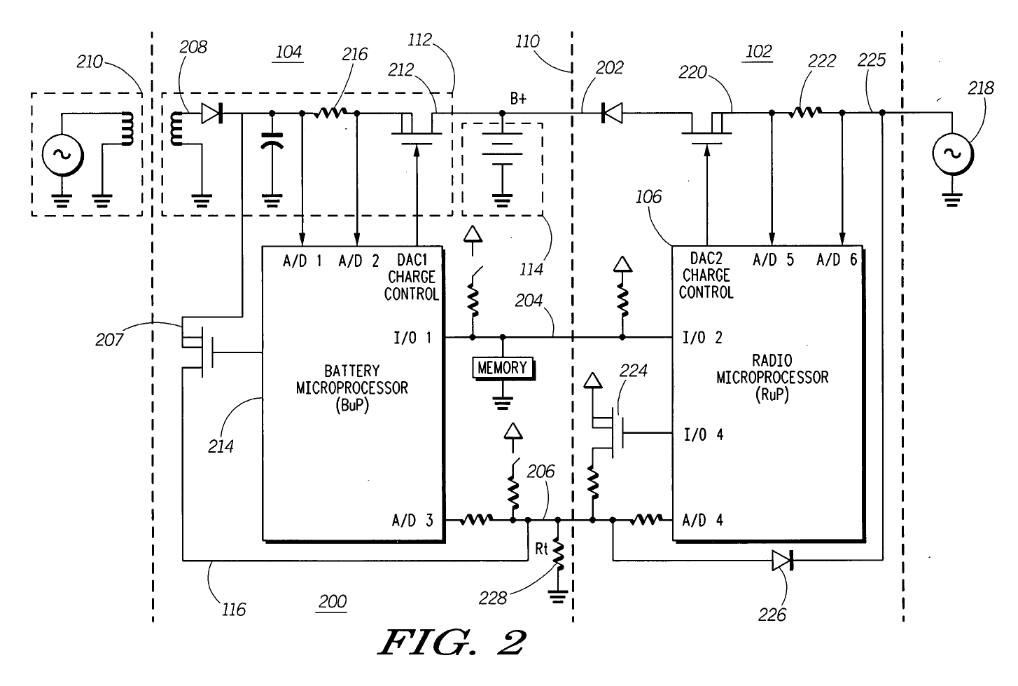

Referring now to FIG. 2, there is shown a detailed block schematic drawing 200 of a battery pack 104 and mobile communication device 102 system, in accordance an embodiment of the invention. The battery pack and communication device are coupled at a radio interface 110, which includes a ground connection 201, a battery B+ line 202, a memory line 204, and a thermistor line 206. The battery pack includes an inductive charging interface 112 which includes a secondary inductive coil and magnetic element 208 for coupling with an external inductive power supply 210. The inducting charging interface also includes a regulator device 212 for controlling charging current to the battery cells 114. Furthermore, the inductive charging interface is coupled to the pass through line 116.

In the particular embodiment described here, the battery pack contains a controller 214 which controls operation of the inductive charging interface, in addition to other functions. For example, charge current may be monitored by monitoring the voltage across a sense resistor 216 in the inductive charging interface. Upon coupling to the external inductive power supply 210, according to the present embodiment, a voltage level from the inductive charging interface is applied to the radio interface through a thermistor line 206. The voltage level may be applied for a preselected period of time sufficient to wake up the charge monitoring circuit 106 by operation of a pass through switch 207, however, in one embodiment of the invention the voltage level is left on the pass through line until the charge monitoring circuit commands the battery controller to turn off the pass through switch 207, which ensures that the charge monitoring circuit is turned on. In the present embodiment the charge monitoring circuit comprises a microprocessor in the communication device that executes instruction code directing the microprocessor in monitoring the charging, such as by communicating with the battery controller 214 over a communication line, such as the memory communication line 204, and by monitoring the temperature via a thermistor circuit coupled to the thermistor line 206. Furthermore, if a radio power supply 218 is coupled to the communication device, the charge monitoring circuit can control charging of the battery through a regulator element 220 and monitor charging current via a sense resistor 222.

There are a variety of events that can occur, and are handled in different ways with the battery pack and mobile communication device system of the invention. When there is no power supply attached to either the battery pack or communication device, both battery and communication device regulators 212, 220, respectively, are off, as is the pass through switch 207. Furthermore, the pull up switch 224 for the thermistor line in the communication device is also open.

If the radio power supply is attached, voltage will be applied from the radio power supply on line 225 to input 221. The presence of voltage at input 221 generates a turn-on event which causes the charge monitoring circuit to wake up and begin operating. Thereafter the charge monitoring circuit may open the regulator device 220 to commence charging. The communication device will also inform the battery controller, if it is active, that the radio power supply is present, so that in case the battery pack is coupled to the inductive power supply, the battery cells are not over charged. It is contemplated that if both the radio and inductive power supplies are present they may be controlled cooperatively to charge the battery.

If the inductive power supply is first coupled to the battery pack, the voltage at the inductive charging interface 112 is detected by, or otherwise activates the battery controller 214. The battery controller may first try to communicate with the charge monitoring circuit to determine if the charge monitoring circuit is already active, such as when a radio power supply is already attached to the mobile communication device, prior to the battery pack being inductively coupled to the inductive power supply. If the controller doesn't receive a response from the communication device, the controller closes the pass through switch 207, which applies the voltage to the thermistor line, and to the power input line 225 through a diode 226. The diode 226 prevents voltage applied to the power input line 225 of the communication device from affecting the thermistor or battery pack when a radio power supply is coupled to the power input line. The charge monitoring circuit will be activated by the voltage from the inductive interface circuit, which will be evident at the power input line 225 and input 221. By applying voltage at input 221, a turn-on event is generated, causing the charge monitoring circuit to be activated. The turn-on event occurs the same as when the radio power supply is attached to the communication device. Upon being activated, the charge monitoring circuit may communicate with the battery controller to determine which power source is being used. Subsequently the battery controller opens the pass through switch 207 so that the charge monitoring circuit can detect the radio power supply if it is subsequently coupled to the communication device.

If both the inductive power supply and radio power supply are connected to the battery and communication device, respectively, then the charge monitoring circuit may command the battery controller to shut off charging from the inductive charging interface, or it may allow power from both sources to charge the battery.

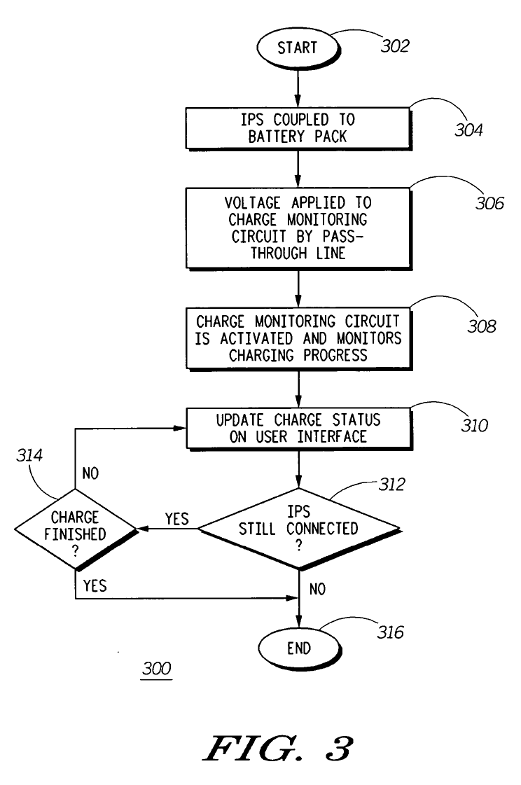

Referring now to FIG. 3, there is shown a flow chart diagram 300 of a method of waking up a charge monitoring circuit of a mobile communication device from a battery pack having an inductive charging interface, in accordance with an embodiment of the invention. At the start 302, the battery pack is coupled to the communication device, and the communication device is powered off. By powered off it is meant that the display, transceiver, and other subsystems of the communication device are turned off so as not to consume power from the battery. Subsequently the inductive power supply is coupled to the battery via an inductive or magnetic interface (304). The resulting voltage may wake up components in the battery pack, such a controller, if present. The voltage is also applied to the charge monitoring circuit in the communication device via the pass through line (306). The voltage activates or otherwise wakes up the charge monitoring circuit, which begins monitoring the charging of the battery (308). While monitoring the charging of the battery, the charge monitoring circuit updates the charging status displayed on the communication device's user interface (310). The charge monitoring and status update continue as long as the inductive power supply is still attached (312) and the battery is not finished charging (314). If the inductive power supply is removed, or if charging is finished, the charge status monitoring ends (316).

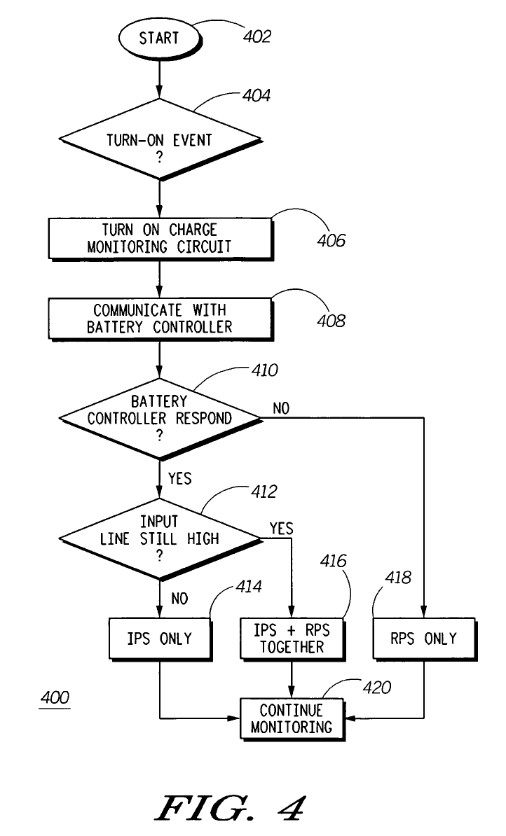

Referring now to FIG. 4, there is shown a flow chart diagram 400 of a method of waking up a charge monitoring circuit of a mobile communication device from a battery pack, in accordance with one embodiment of the invention. At the start 402 the mobile communication device is powered off, including the charge monitoring circuit. Nothing happens until a turn-on event occurs 404. The turn-on event occurs when, for example, a sufficient voltage level is applied to input line 225, and input 221, either by coupling the mobile communication device to a radio power supply, or by coupling the battery pack to an inductive power supply while the battery pack is coupled to the mobile communication device. Upon the occurrence of the turn-on event the charge monitoring circuit is activated 406. Upon becoming activated, the charge monitoring circuit communicates, or attempts to communicate with the battery controller 408, and waits for a response from the battery controller 410. If the battery controller doesn't respond within a time out time period, for example, the charge monitoring circuit concludes that only the radio power supply is present. If the battery controller does respond, the charge monitoring circuit will command the battery controller to remove the voltage level from the pass through line. To ensure the battery controller has turned off the voltage at the pass through line, the charge monitoring circuit may measure the voltage on the thermistor line 206, which should be low due to pull down resistor effect of thermistor 228. Once the charge monitoring circuit has verified that the pass through line has been opened, the input line is checked 412. If the input line is still high, then the charge monitoring circuit concludes that both the radio power supply and inductive power supply are present 416. If the input line is low, then the charge monitoring circuit concludes only the inductive power supply is present 414. Upon determining which power supply or supplies are attached the charge monitoring circuit may continue to monitor for the presence or removal of the power supply or supplies 420.

Therefore the invention provides a battery pack for a mobile communication device which includes an inductive charging interface for inductively coupling to an inductive power supply, and at least one battery cell coupled to the inductive charging interface. The battery cell is charged by the inductive charging interface. To control charging of the battery cell, a controller coupled to the inductive charging interface may be used. The battery pack and communication device are coupled together at a radio interface, and a pass through line is coupled between the inductive charging interface and the radio interface. The pass through line is used for waking up a charge monitoring circuit in the mobile communication device when the inductive charging interface is active. In one embodiment of the invention the pass through line is coupled to a thermistor line of the radio interface. The radio interface may include a communication line coupled to the controller for receiving a shut off command from the mobile communication device when the mobile communication device is coupled to a radio charging supply, in which case the shut off command causes the controller to shut off the inductive charging interface. A battery memory may be coupled to the communication line. The battery memory being used to store battery information, such as charging parameters, charge termination criteria, and so on. A pass through switch in the pass through line, operably coupled to the controller, may be used to open the pass though line at the end of a preselected time period after coupling the battery pack to the inductive power supply.

The invention further provides a method of waking up a charge monitoring circuit of a mobile communication device from a battery pack having an inductive charging interface, commencing with coupling the battery pack to the mobile communication device at a radio interface, and wherein the mobile communication device is powered off, and upon coupling the inductive charging interface to an inductive power supply. Upon coupling the inductive power supply to the battery, the method commences by applying a voltage level from the battery pack to the charge monitoring circuit of the mobile communication device through the radio interface. In response to applying the voltage level to the charge monitoring circuit; the method commences waking up the charge monitoring circuit of the mobile communication device to monitor charging of a battery cell of the battery pack, and providing a charging status on a user interface of the mobile communication device. The voltage level may be applied for a preselected period of time, and upon expiration of the preselected period of time the voltage level is removed. While charging the battery with the inductive power supply a user may commence connecting a radio charging supply to the mobile communication device. In response the method commences communicating a shut off command from the mobile communication device to a controller in the battery pack over a communication line, which causes the battery controller to shut off the inductive charging interface. Communicating the shut off command may be performed over a memory line of the radio interface, wherein the memory line is coupled to a battery memory disposed in the battery pack. In one embodiment of the invention applying the voltage level is performed over a thermistor line of the radio interface.

In another embodiment of the invention, the invention provides a charging system for providing a charging status on a mobile communication device which is presently powered off. The system includes an inductive charging interface disposed in the battery pack for coupling to an inductive power supply, with at least one battery cell coupled to the inductive charge supply which is used for powering the mobile communication device. A charge monitoring circuit is disposed in the mobile communication device and is used for monitoring charging of battery cell or cells. To wake up the charge monitoring circuit a pass through line is coupled between the inductive charging interface and the charge monitoring circuit.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A battery pack for a mobile communication device, comprising:
an inductive charging interface for inductively coupling to an inductive power supply;
at least one battery cell coupled to the inductive charging interface, wherein the at least one battery cell is charged by the inductive charging interface;
a controller for controlling the inductive charging interface;
a radio interface for coupling the battery pack to the mobile communication device; and
a pass through line coupled between the inductive charging interface and the radio interface for waking up a charge monitoring circuit of the mobile communication device when the inductive charging interface is active.

2. A battery pack as defined in claim 1, wherein the pass through line is coupled to a thermistor line of the radio interface.

3. A battery pack as define in claim 1, wherein the radio interface comprises a communication line coupled to the controller for receiving a shut off command from the mobile communication device when the mobile communication device is coupled to a radio charging supply, and wherein the shut off command causes the controller to shut off the inductive charging interface.

4. A battery pack as defined in claim 3, further comprising a battery memory coupled to the communication line, the battery memory for storing battery information.

5. A battery pack as defined in claim 1, further comprising pass through switch in the pass through line, the pass through switch operably coupled to the controller, and wherein the controller opens the pass though switch at the end of a preselected time period after coupling the battery pack to the inductive power supply.

6. A method of waking up a charge monitoring circuit of a mobile communication device from a battery pack having an inductive charging interface, comprising:
coupling the battery pack to the mobile communication device at a radio interface, wherein the mobile communication device is powered off;
coupling the inductive charging interface to an inductive power supply;
applying a voltage level from the battery pack to the charge monitoring circuit of the mobile communication device through the radio interface; and
in response to applying the voltage level to the charge monitoring circuit; waking up the charge monitoring circuit of the mobile communication device to monitor charging of a battery cell of the battery pack, and providing a charging status on a user interface of the mobile communication device.

7. A method of waking up a charge monitoring circuit as defined in claim 6, wherein applying the voltage level comprises applying the voltage level for a preselected period of time, and whereupon expiration of the preselected period of time the voltage lever is removed.

8. A method of waking up a charge monitoring circuit as defined in claim 6, further comprising:
connecting a radio charging supply to the mobile communication device;
communicating a shut off command from the mobile communication device to a controller in the battery pack over a communication line; and
in response to receiving the shut off command, shutting off the inductive charging interface.

9. A method of waking up a charge monitoring circuit as defined in claim 8, wherein communicating the shut off command is performed over a memory line of the radio interface, and wherein the memory line is coupled to a battery memory disposed in the battery pack.

10. A method of waking up a charge monitoring circuit as defined in claim 6, wherein applying the voltage level is performed over a thermistor line of the radio interface.

11. A charging system for providing a charging status on a mobile communication device which is presently power off, the mobile communication device coupled to a battery pack at a radio interface, the system comprising:
a charge monitoring circuit disposed in the mobile communication device, the charge monitoring circuit being activated upon application of a voltage level on a power input line of the mobile communication device, and upon becoming activated determining which of a radio power supply and inductive power supply are available to charge the battery pack.

12. A charging system as defined in claim 11, further comprising a pass through line coupled between the radio interface and the power input line in the mobile communication device.

13. A charging system as defined in claim 12, wherein the pass through line is coupled between a thermistor line of the radio interface and the power input line in the mobile communication device.

14. A charging system as defined in claim 12, further comprising a diode in line in the pass through line in the mobile communication device.

15. A charging system as defined in claim 11, further comprising:
an inductive charging interface disposed in the battery pack for coupling to an inductive power supply;
at least one battery cell coupled to the inductive charge supply and for power the mobile communication device; and
a pass through line coupled between the inductive charging interface and the radio interface for coupling to the pass through line in the mobile communication device.

16. A charging system as defined in claim 15, wherein the pass through line is coupled to the radio interface at a thermistor line of the radio interface.

17. A charging system defined in claim 11, wherein the radio interface comprises a communication line coupled to a controller disposed in the battery pack for receiving a shut off command from the mobile communication device when the mobile communication device is coupled to a radio charging supply, and wherein the shut off command causes the controller to shut off the inductive charging interface.

18. A charging system as defined in claim 17, further comprising a battery memory coupled to the communication line, the battery memory for storing battery information.

19. A charging system as defined in claim 15, further comprising pass through switch in the pass through line, the pass through switch operably coupled to the controller, and wherein a controller disposed in the battery pack opens the pass though switch to remove the voltage from the pass through line at the radio interface.
